(19) United States
(12) Patent Application Publication
(10) Pub. No.: US 2014/0054864 A1
(43) Pub. Date: Feb. 27, 2014

(54) SEALING ASSEMBLY AND PROTECTOR RING

(71) Applicant: Carl Freudenberg KG, Weinheim (DE)

(72) Inventors: Christian KOHL, Hirschberg (DE); Jens HOFMANN, Mannheim (DE)

(73) Assignee: Carl Freudenberg KG, Weinheim (DE)

(21) Appl. No.: 13/972,949

(22) Filed: Aug. 22, 2013

(30) Foreign Application Priority Data
Aug. 22, 2012 (DE) 10 2012 016 559.5

(51) Int. Cl. F16J 15/32

(52) U.S. Cl. CPC F16J 15/32
USPC 277/549

(57) ABSTRACT

A sealing assembly for sealing a surface of a machine element from a medium on one side and surroundings on the other side includes a sealing ring and a protector ring. The sealing ring has at least one dynamically stressed sealing lip configured to contact, in a sealing manner, the surface to be sealed. The protector ring is disposed on a side of the sealing lip that is to be axially remote from the medium. The protector ring has a circumferential surface configured to be disposed adjacent to the surface to be sealed with a radial spacing such that the circumferential surface delimits a choke gap together with the surface to be sealed. The circumferential surface of the protector ring includes a conveying structure having a conveying direction that is axially away from the sealing lip and towards the surroundings.

### CROSS-REFERENCE TO PRIOR APPLICATION

Priority is claimed to German Patent Application No. DE 10 2012 016 559.5, filed on Aug. 22, 2012, the entire disclosure of which is hereby incorporated by reference herein.

### FIELD

The invention relates to a sealing assembly comprising a sealing ring and a protector ring, the sealing ring comprising at least one dynamically stressed sealing lip, which comes into contact in a sealing manner with a surface, which is to be sealed, of a machine element to be sealed, the protector ring comprising a circumferential surface which is adjacently associated with the surface, which is to be sealed, with radial spacing and which delimits a choke gap together with the surface, and the protector ring being arranged on the side of the sealing lip which is axially remote from a medium to be sealed.

### BACKGROUND

A sealing assembly of this type is known from DE 197 05 428 A1. The sealing ring is formed as a rotary shaft seal and is used as a seal for a toothed rack. The protector ring is provided with an annular indentation in the region of its circumferential surface, which faces the surface, which is to be sealed, of the machine element to be sealed. Contaminants can collect in this indentation, which contaminants infiltrate under the protector ring from the surroundings. By means of this reservoir for the contaminants, it is intended that the contaminants be prevented from penetrating as far as the dynamically stressed sealing lip and from damaging or destroying said sealing lip.

### SUMMARY

In an embodiment, the present invention provides a sealing assembly for sealing a surface of a machine element from a medium on one side and surroundings on the other side. The sealing assembly includes a sealing ring and a protector ring. The sealing ring has at least one dynamically stressed sealing lip configured to contact, in a sealing manner, the surface to be sealed. The protector ring is disposed on a side of the sealing lip that is to be axially remote from the medium. The protector ring has a circumferential surface configured to be disposed adjacent to the surface to be sealed with a radial spacing such that the circumferential surface delimits a choke gap together with the surface to be sealed. The circumferential surface of the protector ring includes a conveying structure having a conveying direction that is axially away from the sealing lip and towards the surroundings.

### BRIEF DESCRIPTION OF THE DRAWING

The present invention will be described in even greater detail below based on the exemplary figure. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawing which illustrates the following:

FIG. 1 shows the sealing assembly according to an embodiment of the present inventions.

### DETAILED DESCRIPTION

In an embodiment, the present invention provides a sealing assembly in which the choke gap is delimited in the radial direction on one hand by the surface, which is to be sealed, of the machine element to be sealed, and in the radial direction on the other hand by the circumferential surface of the protector ring. The choke gap is kept at least largely free of contaminants during the intended use of the sealing assembly.

In an embodiment, the circumferential surface of the protector ring comprises a conveying structure having a conveying direction which is axially away from the sealing lip and towards the surroundings. By means of the conveying structure on the circumferential surface of the protector ring, contaminants which have penetrated the choke gap are conveyed out of the choke gap during the intended use of the sealing assembly, therefore when the machine element to be sealed rotates relative to the sealing ring and to the protector ring in a conveying direction which is axially away from the sealing lip and towards the surroundings. The choke gap is therefore always free of contaminants. The sealing lip is protected in the best possible manner thereby.

In addition to these advantageous performance characteristics, the protector ring provides additional protection for the sealing lip in order to reduce to a minimum the risk of damage to the sealing lip during assembly of the machine element to be sealed. By means of the protector ring, the machine element to be sealed is pre-centred relative to the sealing lip during its assembly.

For consistently good performance characteristics of the sealing assembly over a long service life, it is important that contaminants do not solidify in the choke gap and/or do not pass through the choke gap towards the sealing lip. Contaminants of this type may be formed for example from dust, dirt or water.

The sealing assembly can be used in motor vehicles, both in passenger vehicles and in commercial vehicles. The use of the sealing assembly in front-wheel-drive commercial vehicles is particularly advantageous. For such a use, the sealing assembly has to be particularly well protected against undesired external influences.

It is also possible for the sealing assembly to be used for example in vehicle transmissions, in particular on the rear-axle differential input or on the axle shafts. In commercial vehicles, the sealing assemblies are exposed to extremely disadvantageous environmental influences and are impinged upon by dirt or dirty water, for example. When cleaning the vehicle using pressure washers, these contaminants may penetrate into the choke gap of the sealing assembly owing to the direct effect of the jet of the pressure washer. During the intended use of the sealing assembly, the contaminants are conveyed out of the choke gap into the surroundings by the conveying structure of the circumferential surface of the protector ring. The choke gap is then free from contaminants again.

The conveying structure may be formed by a return-feed spiral groove. The return-feed spiral groove can be unidirectional or bidirectional, depending on the use in question. By means of a return-feed spiral groove of this type, the contaminants in the choke gap are conveyed back axially away from the sealing lip towards the surroundings, from where they also penetrated into the choke gap.

The return-feed spiral groove may be formed by spiral ribs or spiral arcs. Alternatively, the return-feed spiral groove may be formed by a conveying thread.

Spiral ribs, spiral arcs or conveying threads in sealing assemblies are known. In this case, the conveying structure in the form of a return-feed spiral groove is a component of the dynamically stressed sealing lip, which consists of a rubber-resilient sealing material. The known return-feed spiral groove of the sealing lips conveys a medium, which is to be sealed and is used to lubricate the sealing lip, back into the space to be sealed. In addition, the known conveying structure comes into contact with the surface, which is to be sealed, of the machine element to be sealed.

In the sealing assembly according to an embodiment of the invention, the conveying structure does not, however, contact the surface, which is to be sealed, of the machine element to be sealed. The conveying structure surrounds the surface to be sealed with radial spacing, that is to say contactlessly, the choke gap being formed by the radial spacing. The effect of the conveying structure is based on shear forces in the medium to be sealed, which forces arise when the sealing ring and the protector ring rotate relative to the surface to be sealed.

The protector ring may consist of a polymer material. The protector ring therefore has good durability, even if contaminants are frequently conducted out of the choke gap towards the surroundings, out of the sealing assembly, over a long service life of said sealing assembly.

According to an advantageous configuration, it can be provided that the protector ring consists of a fibreglass-reinforced polyamide material, for example of fibreglass-reinforced PA 6.6. The protector ring is sufficiently durable. The circumferential surface thereof can be simply and cost-effectively provided with the conveying structure.

The protector ring and the sealing ring may form a pre-assemblable unit. By means of a configuration of this type, the storage of the sealing ring and the protector ring before the installation thereof in the sealing assembly is simplified, as is the mounting of the pre-assemblable unit in the sealing assembly. For mounting the sealing ring and protector ring in the sealing assembly, it is sufficient to mount the pre-assemblable unit, in which both parts are contained. The assembly is therefore reliable in terms of process; the risk of assembly errors is kept to a minimum.

The protector ring and the sealing ring may be interconnected with a positive fit. A positive connection of this type is simple to produce. For this purpose, the protector ring can be mounted in a recess of the sealing ring, the recess consisting for example of rubber-resilient material.

The protector ring may comprise at least one retaining claw, which can be latched in one congruent undercut of the sealing ring. Latching connections of this type are simple and cost-effective to produce. In addition, mounting the protector ring in the sealing ring is particularly simple, for example in that a recess, consisting of an elastomeric material, in the sealing ring is resiliently expanded when mounting the protector ring and then springs back again when the at least one retaining claw of the protector ring latches in the at least one undercut. The retaining claw may, for example, be bead-shaped and circular in a closed manner.

According to another configuration, a plurality of retaining claws distributed in the circumferential direction can also be provided, the retaining claws preferably being evenly distributed in the circumferential direction in a case such as this.

Separated recycling of the pre-assemblable unit is made easier by the positive connection between the sealing ring and the protector ring.

The ratio between the axial width of the choke gap and the radial height thereof may be at least 3. Further preferably, the ratio is 15. The sealing assembly according to an embodiment of the invention thus combines the functional advantages of a solid protector ring which does not contact the surface to be sealed with maximum protection of the sealing lip against contaminants by means of a choke gap which is narrow and as long as possible, and has a conveying function.

In addition, an embodiment of the invention relates to a pre-assemblable unit, comprising a sealing ring and a protector ring of a sealing assembly as described above, wherein the protector ring comprises the circumferential surface having a conveying structure.

An embodiment of the invention further relates to a protector ring for a sealing assembly as described above, which ring has a circumferential surface which faces a surface to be sealed, wherein the circumferential surface comprises the conveying structure.

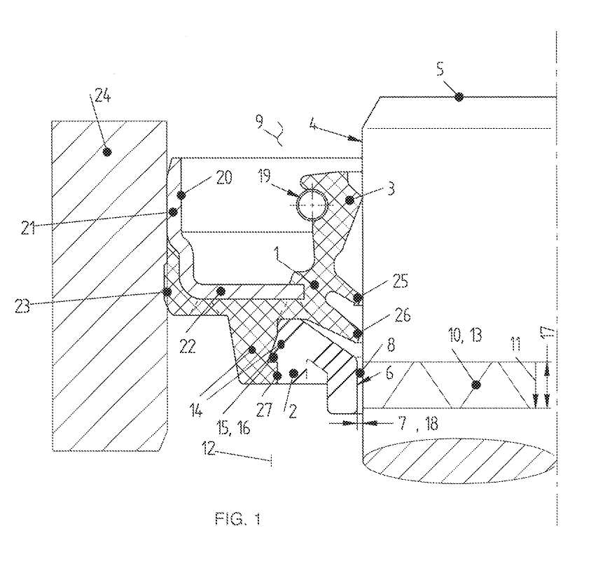

FIG. 1 schematically shows an embodiment of a sealing assembly. In this embodiment, the sealing ring 1 is formed as a rotary shaft seal. The sealing lip 3 is surrounded on the outer circumference thereof by an annular helical spring 19. The sealing ring 1 also comprises a substantially L-shaped bearing ring 20, which consists of a tough, for example metal, material. A statically stressed sealing bead 23 is arranged on the axial leg 21 of the bearing ring 20 in the region of transition to the radial leg 22, which bead seals against the housing 24.

The sealing lip 3 is coupled with the radial leg 22 radially on the inside. In addition, in the embodiment shown, the sealing ring 1 comprises two front sealing lips 25, 26, which are arranged on the side of the sealing lip 3 which is axially remote from the medium 9 to be sealed. A grease filling may be provided between the front sealing lips 25, 26. The protective effect for the sealing lip 3 is further improved thereby.

The sealing lip 3 and the two front sealing lips 25, 26 transition into one another in one piece and are formed from a single material. The sealing lip 3 and the front sealing lips 25, 26 come into contact in a sealing manner under resilient prestress with the surface 4, which is to be sealed, of the machine element 5 to be sealed.

A recess 27 for the protector ring 2 is provided on the side of the sealing lip 3 which is axially remote from the radial leg 22, which recess consists of a rubber-resilient material and is formed together with the sealing lip 3 and the two front sealing lips 25, 26 in a manner transitioning into one another in one piece and being formed from a single material. The recess 27 forms a component of the sealing ring 1 and comprises a circular undercut 16, into which the congruent, circular retaining claw 15 of the protector ring 2 can be latched.

The sealing ring 1 and the protector ring 2 form the pre-assemblable unit 14.

The circumferential surface 6 of the protector ring 2 is adjacently associated with the surface 4, which is to be sealed, with radial spacing 7. The surface 4 to be sealed and the circumferential surface 6 delimit the choke gap 8 in the radial direction. The circumferential surface 6 of the protector ring 2 comprises a conveying structure 10 having a conveying direction 11 which is axially away from the sealing lip 3 and the front sealing lips 25, 26 and towards the surroundings 12. The conveying structure 10 is formed by a return-feed spiral groove 13.

The protector ring 2 consists of fibreglass-reinforced polyamide 6.6 and is therefore particularly durable.

In the embodiment shown, the ratio between the axial width 17 of the choke gap 8 and the radial height 18 thereof is 15.

During the intended use of the sealing assembly, contaminants which are inside the choke gap 8 are conveyed in the conveying direction 11 out of the choke gap 8 towards the surroundings 12 by the conveying structure 10 of the circumferential surface 6 of the protector ring 2. The choke gap 8 is therefore always free of contaminants. The sealing lip 3 and the front sealing lips 25, 26 are protected in the best possible manner against the impingement of contaminants.

The sealing assembly has consistently good performance characteristics over a long service life owing to the protector ring 2 and in particular owing to the circumferential surface 6 thereof comprising the conveying structure 10.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 sealing ring
2 protector ring
3 sealing lip
4 surface of 5 to be sealed
5 machine element
6 circumferential surface of 2
7 radial spacing between 2 and 4
8 choke gap
9 medium to be sealed
10 conveying structure
11 conveying direction
12 surroundings
13 return-feed spiral groove
14 pre-assemblable unit of 1 and 2
15 retaining claw
16 undercut
17 axial width of 8
18 radial height of 8
19 annular helical spring
20 bearing ring
21 axial leg
22 radial leg
23 statically stressed sealing bead
24 housing
25 front sealing lip
26 front sealing lip
27 recess for 2

What is claimed is:

1. A sealing assembly for sealing a surface of a machine element from a medium on one side and surroundings on the other side, the sealing assembly comprising:
a sealing ring having at least one dynamically stressed sealing lip configured to contact, in a sealing manner, the surface to be sealed; and
a protector ring disposed on a side of the sealing lip that is to be axially remote from the medium, the protector ring having a circumferential surface configured to be disposed adjacent to the surface to be sealed with a radial spacing such that the circumferential surface delimits a choke gap together with the surface to be sealed, the circumferential surface of the protector ring including a conveying structure having a conveying direction that is axially away from the sealing lip and towards the surroundings.

2. The sealing assembly according to claim 1, wherein the conveying structure is a return-feed spiral groove.

3. The sealing assembly according to claim 2, wherein the return-feed spiral groove includes spiral ribs or spiral arcs.

4. The sealing assembly according to claim 2, wherein the return-feed spiral groove is a conveying thread.

5. The sealing assembly according to claim 1, wherein the protector ring consists of a polymer material.

6. The sealing assembly according to claim 5, wherein the protector ring consists of a fibreglass-reinforced polyamide material.

7. The sealing assembly according to claim 1, wherein the protector ring and the sealing ring form a pre-assemblable unit.

8. The sealing assembly according to claim 1, wherein the protector ring and the sealing ring are interconnected with a positive fit.

9. The sealing assembly according to claim 1, wherein the protector ring includes at least one retaining claw configured to latch into at least one congruent undercut of the sealing ring.

10. The sealing assembly according to claim 1, wherein a ratio between an axial width of the choke gap and a radial height of the choke gap is at least 3.

11. A pre-assemblable unit for sealing a surface of a machine element from a medium on one side and surroundings on the other side, the sealing assembly comprising:
a sealing ring having at least one dynamically stressed sealing lip configured to contact, in a sealing manner, the surface to be sealed; and
a protector ring configured to be disposed on a side of the sealing lip that is to be axially remote from the medium, the protector ring having a circumferential surface configured to be disposed adjacent to the surface to be sealed with a radial spacing such that the circumferential surface delimits a choke gap together with the surface to be sealed, the circumferential surface of the protector ring including a conveying structure having a conveying direction that is axially away from the sealing lip and towards the surroundings.

12. A protector ring for a sealing assembly for sealing a surface of a machine element from a medium on one side and surroundings on the other side, the sealing assembly including a sealing ring having at least one dynamically stressed sealing lip configured to contact, in a sealing manner, the surface to be sealed, the protector ring being configured to be disposed on a side of the sealing lip that is to be axially remote from the medium, the protector ring comprising:
a circumferential surface configured to be disposed adjacent to the surface to be sealed with a radial spacing such that the circumferential surface delimits a choke gap together with the surface to be sealed, the circumferential surface of the protector ring including a conveying structure having a conveying direction that is axially away from the sealing lip and towards the surroundings.
